(19) United States
(12) Patent Application Publication
(10) Pub. No.: US 2021/0105281 A1
(43) Pub. Date: Apr. 8, 2021

(54) METHOD AND APPARATUS FOR SINGLE-SIGNATURE CONTENT INTEGRITY AND PROVENANCE VALIDATION FOR NAMED DATA NETWORKING

(71) Applicant: ELECTRONICS AND TELECOMMUNICATIONS RESEARCH INSTITUTE, Daejeon (KR)

(72) Inventors: Yong Yoon SHIN, Sejong-si (KR); Sae Hyong PARK, Daejeon (KR)

(73) Assignee: ELECTRONICS AND TELECOMMUNICATIONS RESEARCH INSTITUTE, Daejeon (KR)

(21) Appl. No.: 17/036,494

(22) Filed: Sep. 29, 2020

(30) Foreign Application Priority Data
Oct. 2, 2019 (KR) 10-2019-0122525
Sep. 4, 2020 (KR) 10-2020-0112879

(51) Int. Cl. H04L 29/06; G06F 21/64; G06F 16/22

(52) U.S. Cl. CPC H04L 63/104; G06F 21/64; G06F 16/2255; G06F 16/2246; H04L 63/20

(57) ABSTRACT

Disclosed herein is a system and method for validating data integrity and provenance in named data networking (NDN). For more efficient security in NDN, per-segment provenance and data integrity are verified by minimizing the number of signing operations regardless of the size of data using the attributes of a Merkle tree. Generation and validation of a manifest with per-segment provenance and integrity of a file is possible regardless of the size of the file, thereby reducing burden of computing.

### CROSS REFERENCE TO RELATED APPLICATION

The present application claims priority to KR 10-2019-0122525, filed Oct. 2, 2019 and KR 10-2020-0112879 filed Sep. 4, 2020, the entire contents of which is incorporated herein for all purposes by this reference.

### BACKGROUND OF THE INVENTION

### 1. Field of the Invention

The present invention relates to computer network, named data networking and security networking.

### 2. Description of the Related Art

Named data networking (hereinafter referred to as NDN) is used under the same concept as content-centric networking (hereinafter referred to as CCN) and is one of examples of implementing future networks discussed in information centric networking (hereinafter referred to as ICN).

In NDN, content is composed of a set of segments and a per-packet signature is used to guarantee provenance and integrity of data itself, not based on network connection. Consumers may validate provenance and integrity of data with a public key-based signature attached to each data packet. However, a signature generation and validation process has limitations that impose significant burdens on consumers and producers.

### SUMMARY OF THE INVENTION

The present invention is devised to solve the above-described problem for more efficient security in NDN, and an object of the present invention is to verify per-segment provenance and data integrity by minimizing the number of signing operations regardless of the size of the data using the attributes of a Merkle tree.

Other objects and advantages of the present invention can be understood by the following description, and will be more clearly understood by embodiments of the present invention. In addition, it will be easily understood that the objects and advantages of the present invention can be realized by the means shown in the claims and combinations thereof.

As an aspect of the present invention, a method of validating data integrity in named data networking(NDN) by a producer device includes generating a data segment and constructing a Merkle tree by hashing the data segment, transmitting a manifest generated based on a policy, and transmitting a data segment requested by a consumer and a Merkle hash. The transmitting of the manifest may be performed in the form of a signed packet.

The Merkle tree may be a k-array Merkle tree. The Merkle tree may be a binary Merkle tree. The manifest may include Merkle hash information and order information of the data segment.

The policy may include a single group policy, and the single group policy may be a policy in which the Merkle hash information includes a Merkle root and the order information of the data segment includes a start and end number of a data segment.

The policy may include a segment group policy, and the segment group policy may be a policy in which the Merkle hash information includes a Merkle root and the order information of the data segment includes a start and end number of a data segment for each data segment group.

The policy may include a Merkle hash group policy, and the Merkle hash group policy may be a policy in which the Merkle hash information includes a Merkle hash group and the order information of the data segment includes a start and end number of a data segment for each data segment group.

As another aspect of the present invention, a method of validating data integrity in named data networking(NDN) by a consumer device includes requesting data from a producer, receiving a manifest generated according to a policy, receiving a data segment based on the manifest, and comparing a Merkle hash based on the data segment with a Merkle hash based on the manifest. The receiving of the manifest is performed in the form of a signed packet.

The manifest may include Merkle hash information and order information of the data segment. The Merkle hash based on the manifest may be generated based on a Merkle tree.

The policy may include a single group policy, and the single group policy may be a policy in which the Merkle hash information includes a Merkle root and the order information of the data segment includes a start and end number of a data segment.

The policy may include a segment group policy, and the segment group policy may be a policy in which the Merkle hash information includes a Merkle root and the order information of the data segment includes a start and end number of a data segment for each data segment group.

The policy may include a Merkle hash group policy, and the Merkle hash group policy may be a policy in which the Merkle hash information includes a Merkle hash group and the order information of the data segment includes a start and end number of a data segment for each data segment group.

As another aspect of the present invention, an apparatus for validating data integrity in named data networking (NDN) includes a segment generator configured to generate a data segment by dividing data, a Merkle tree generator configured to construct a Merkle tree by hashing the data segment, a policy generator configured to construct a policy for providing the data segment, a manifest generator configured to generate a manifest file generated according to the policy, and a data provider configured to provide a manifest file in which a first packet provided by a producer is a signed packet.

The manifest may include Merkle hash information and order information of the data segment.

The policy may include a single group policy, and the single group policy may be a policy in which the Merkle hash information includes a Merkle root and the order information of the data segment includes a start and end number of a data segment.

The policy may include a segment group policy, and the segment group policy may be a policy in which the Merkle hash information includes a Merkle root and the order information of the data segment includes a start and end number of a data segment for each data segment group.

The policy may include a Merkle hash group policy, and the Merkle hash group policy may be a policy in which the Merkle hash information includes a Merkle hash group and the order information of the data segment includes a start and end number of a data segment for each data segment group.

The Merkle tree may be a binary Merkle tree. The Merkle tree may be a k-array Merkle tree.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a manifest structure proposed in the present invention;

FIG. 2 is a view showing a data integrity verification procedure in named data networking (NDN) using a manifest proposed in the present invention;

FIG. 3 is a view showing a producer procedure of using a manifest proposed in the present invention;

FIG. 4 is a view illustrating levels of a binary Merkle tree and a k-array Merkle tree applicable to the present invention.

FIG. 5 is a view showing a consumer procedure of using a manifest proposed in the present invention;

FIG. 6 is a view showing a Merkle tree illustrating single-signature-based data integrity verification applicable to the present invention;

FIG. 7 is a view showing a binary tree illustrating data integrity verification using a segment group applicable to the present invention;

FIG. 8 is a view showing a k-array tree illustrating data integrity verification using a segment group applicable to the present invention;

FIG. 9 is a view showing a Merkle tree illustrating data integrity verification using a Merkle hash group applicable to the present invention;

FIG. 10 is a view showing a data integrity verification procedure according to a single group policy applicable to the present invention;

FIG. 11 is a view showing a data integrity verification procedure according to a segment group policy applicable to the present invention;

FIG. 12 is a view showing a data integrity verification procedure according to a Merkle hash group policy applicable to the present invention;

FIG. 13 is a view showing a block structure applicable to the present invention;

FIG. 14 is a view showing an apparatus used by a producer, which is applicable to the present invention;

FIG. 15 is a view showing an apparatus used by a consumer, which is applicable to the present invention; and

FIG. 16 is a view showing a device applicable to the present invention.

### DESCRIPTION OF THE PREFERRED EMBODIMENTS

Reference will now be made in detail to the preferred embodiments of the present invention, examples of which are illustrated in the accompanying drawings. The detailed description set forth below in connection with the appended drawings is intended as a description of exemplary embodiments and is not intended to represent the only embodiments in which the concepts explained in these embodiments can be practiced. The detailed description includes details for the purpose of providing an understanding of the present invention. However, it will be apparent to those skilled in the art that these teachings may be implemented and practiced without these specific details.

The embodiments of the present invention described below are combinations of elements and features of the present invention in specific forms. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or elements of any one embodiment may be included in another embodiment and may be replaced with corresponding constructions or features of another embodiment.

It should be noted that specific terms disclosed in the present invention are proposed for better understanding of the present invention, and the use of these specific terms may be changed to another format within the technical scope or spirit of the present invention.

In some instances, well-known structures and devices are omitted in order to avoid obscuring the concepts of the present invention and the important functions of the structures and devices are shown in block diagram form. The same reference numbers will be used throughout the drawings to refer to the same or like parts.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Throughout the specification, when a certain portion “includes” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof.

A signature generation and validation process has limitations that impose significant burdens on both consumers and producers. In order to solve such limitations and burden of generating signatures on real-time streaming data producers, an embedded manifest method has been proposed. In the embedded manifest method, a signed embedded manifest composed of a digest of subsequent data packets is added for each packet group. In addition, in the embedded manifest method, only the digest of the data packet is added to signatureinfo, thereby reducing the number of signing operations based on a public key and validating provenance and integrity of data.

For example, when it is assumed that a total amount of content with a segment size of 1,500 B is 1.5G and 20 digests are included in one manifest, 50,000 signatures are required. This is significantly improved as compared to an original NDN approach requiring 1M signatures per packet. However, this means that, if there are n segments in a data file, k manifest signatures

$$( \frac{number of segments in a life}{number of digests in a manifest} )$$

for n segment groups are required.

With an exponential increase in terminals for producing content and explosive development of performance, enormous content has been produced. In the case of such enormous content, since a packet group is divided into multiple groups and thus multiple digests are eventually generated. A producer needs to sign all embedded manifest packets.

The present invention relates to a method of remarkably reducing the number of signing operations using the characteristics of a Merkle tree and verifying per-segment provenance and data integrity regardless of the size of data. Hereinafter, the embodiments of the present invention will be described in detail with reference to the accompanying drawings.

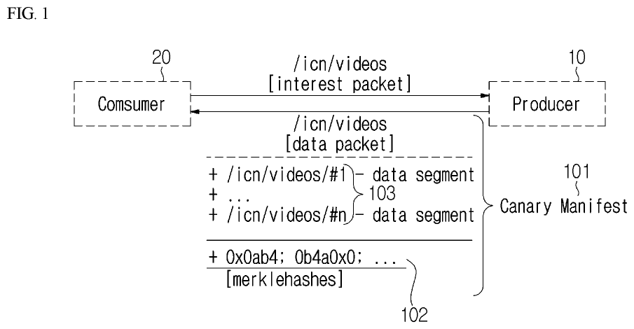

NDN includes a plurality of NDN routers and an NDN node. Referring to FIG. 1, the NDN nodes include one or more consumers 20 and a producer 10. The present invention includes a consumer using a Merkle tree based manifest, a producer and NDN.

FIG. 1 is a view showing a manifest structure proposed in the present invention. When the consumer 20 requests data through an interest packet, the producer 10 responds to the consumer's request for the data. The producer may transmit a manifest file as a response. The manifest 101 file may include the order of data segments 103 and Merkle hash information 102.

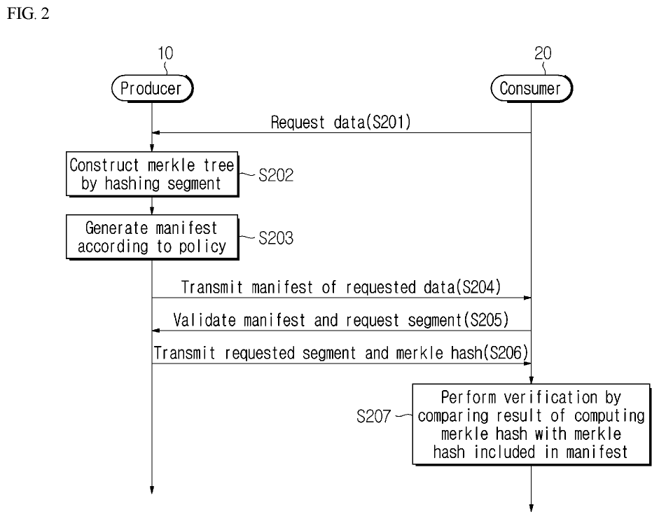

FIG. 2 is a view showing a data integrity verification procedure in named data networking (NDN) using a manifest proposed in the present invention.

Referring to FIG. 2, in step S201, the consumer requests data from the producer. The consumer may request data using interest packet.

In step S202, the producer constructs a Merkle tree by hashing a data segment. The producer divides the data into pieces when the size of the data exceeds a limit. The piece may be referred to as a segment. The size of the data segment may be determined by the producer. The producer knows the data segment and thus may construct the Merkle tree by hashing each data segment. In one embodiment, the producer may construct a Merkle tree using an encryption hashing scheme.

In step S203, the producer generates a manifest according to the policy. The policy includes a single group policy, a segment group policy and a Merkle hash group policy. In one embodiment, the single group policy, the segment group policy and the Merkle hash group policy may be used independently or together.

The single group policy refers to a policy for generating a manifest including Merkle root information and start and end number information of a data segment. The segment group policy refers to a policy for generating a manifest including Merkle root information and start and end number information of a data segment for each data segment group. The Merkle hash group policy refers to a policy for generating a manifest including a Merkle hash group and a start and end number of a data segment for each data segment group. The Merkle hash group is a group of a Merkle root and a Merkle hash.

In step S204, the producer may transmit the manifest file of the data requested by the consumer. This procedure is provided in the form of a signed packet. This is a signing method in which the number of signing operations is much smaller than the number of signing operations in the embedded manifest method, thereby reducing the burden of signing on the producer and the consumer.

In step S205, the consumer may validate manifest information and request a data segment from the producer. The manifest is constructed in the format, to which the policy is applied, and the consumer validates information on the manifest. This procedure is performed in the form of the signed packet and this procedure completes signature related operation. The consumer may request a data segment based on the checked manifest. The request for the data segment may include a data segment number.

In step S206, the producer may transmit the requested data segment and a Merkle hash in the form of a digest to the consumer. For example, a data segment transport packet may include root hash information of the segment in a digest portion.

In step S207, the consumer may perform verification by comparing a result of computing the Merkle hash with the Merkle hash included in the manifest. When they match as the result of comparison, this means that integrity of the data segment is verified, and the consumer may request a next data segment. When they do not match as the result of comparison, this means that integrity of the data segment is violated, and thus the consumer may take necessary actions without requesting a next segment.

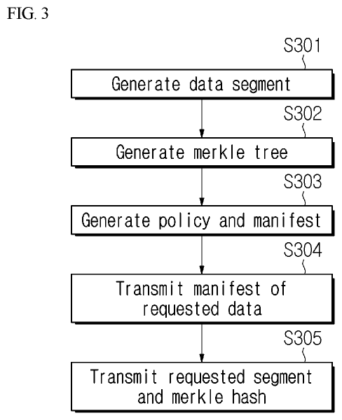

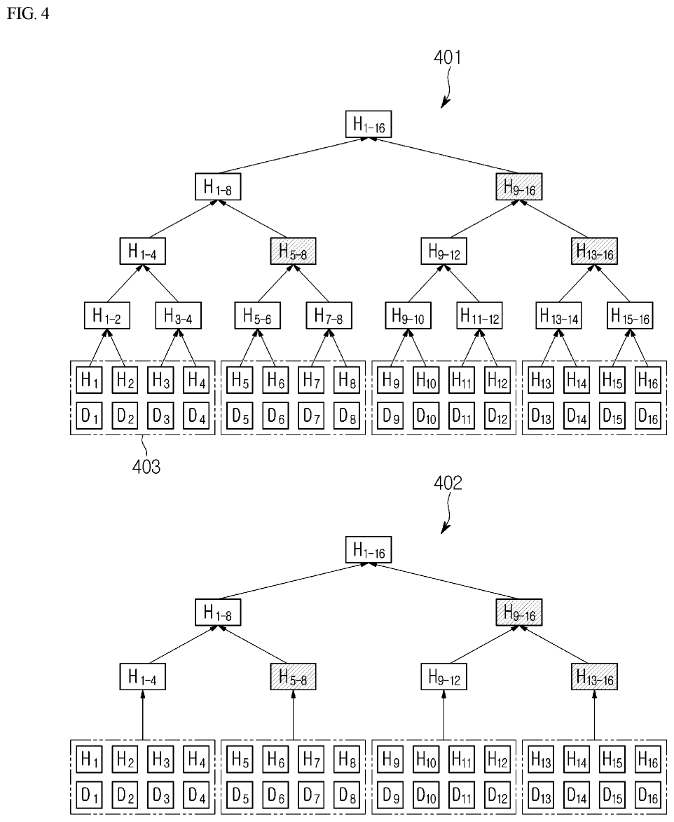

FIG. 3 is a view showing a producer procedure of using a manifest proposed in the present invention. FIG. 4 is a view illustrating levels of a binary Merkle tree and a k-array Merkle tree applicable to the present invention. Hereinafter, the producer procedure will be described in detail with reference to FIGS. 3 and 4.

Referring to FIG. 3, in step S301, the producer may generate a data segment. The producer is an entity for providing data. The producer divides data into pieces when the size of the data exceeds a limit. The piece may be referred to as a segment. The size of the data segment may be determined by the producer.

In step S302, the producer generates a Merkle tree. More specifically, the producer knows the data segment and thus may construct the Merkle tree by hashing each data segment, in order to generate a Merkle root and a Merkle hash. In one embodiment, the producer may construct the Merkle tree using an encryption hashing scheme.

In step S303, the producer generates a policy and a manifest. The policy includes a single group policy, a segment group policy and a Merkle hash group policy. The producer may generate a manifest corresponding to the applied policy. Hereinafter, each policy will be described in detail.

The single group policy is a verification policy based on a basic Merkle tree. The manifest may include a start and end number of a segment and a Merkle root hash.

The segment group policy refers to a policy for reducing the verification step of the consumer by grouping leaves (segments) of the Merkle tree in producer-designated or automated units. The manifest includes Merkle root hash information and segment group information. The segment group may include start and end numbers of the grouped segments. A binary tree format is not necessarily taken and a Merkle tree level may be reduced based on k-array. The number of digests which need to be additionally transmitted may be expressed as logₖ n (k: array, n: the number of segments).

Referring to FIG. 4, as one embodiment of the present invention, a tree 401 above is a binary tree and a tree 402 below is a k-array tree in case of k=4. Four data segments are constructed in one data segment group 403. It can be seen that the k-array tree 402 has a lower Merkle tree level than the binary tree 401.

The Merkle hash group policy refers to a policy for reducing the verification step of the consumer by grouping Merkle roots and Merkle hashes in producer-designated units or automated units. The Merkle root may be used interchangeable with a Merkle root node. The Merkle hash may be used interchangeable with a Merkle hash node. The number of segments generated by dividing a very large amount of data is beyond imagination. In this case, when the producer constructs the Merkle tree, the depth of the tree very increases. Accordingly, the producer needs to provide a hint capable of computing the Merkle root in the form of a digest when transmitting the segment requested by the consumer. The Merkle hash group policy refers to a policy to prepare the case where the number of segments generated by dividing the data is very large and the number of Merkle hashes to be included in the digest increases to exceed a packet capacity.

The manifest may include single group information, segment group information and Merkle hash group information, and the Merkle hash group information may include grouped Merkle root and Merkle hash information.

In step S304, the producer transmits the manifest of the requested data. The producer transmits a manifest file generated by applying the policy as a first response to the requested data. This procedure is provided in the form of a signed packet. This is a signing method in which the number of signing operations is much smaller than the number of signing operations in the embedded manifest method, thereby reducing the burden of signing on the producer and the consumer.

In step S305, the producer transmits the requested data segment and the Merkle hash. The Merkle hash may follow a digest format. The producer may transmit a segment as a response to the segment number requested by the consumer. The digest portion of the segment transport packet may include root hash information of the segment. The Merkle hash to be included in the digest is constructed based on the applied policy.

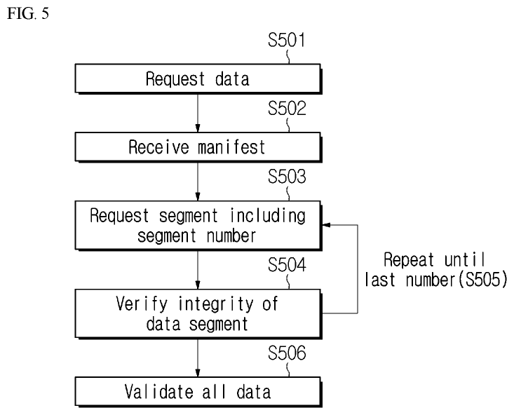

FIG. 5 is a view showing a consumer procedure of using a manifest proposed in the present invention. Hereinafter, the consumer procedure will be described in detail with reference to FIG. 5.

Referring to FIG. 5, in step S501, the consumer requests data from the producer. The consumer may request the data through the name of the data. In addition, the consumer may request the data through an interest packet. A first packet received as a response thereto is a manifest packet. The manifest is constructed in the format of the applied policy.

In step S502, the consumer receives the manifest. The producer generates a data segment in response to the consumer's request for the data and constructs the Merkle tree by hashing the generated data segment. The producer generates a manifest based on the Merkle tree and the order information of the data segment and transmits the manifest to the consumer. Accordingly, the consumer may confirm the order information of the data segment by receiving the manifest, and request the data from the producer using the order information. This procedure is provided in the form of a packet and signature related operation ends with this procedure.

In step S503, the consumer requests a segment including a segment number. More specifically, the consumer may transmit a request for a data segment including a segment number to the producer based on the received manifest information.

In step S504, the consumer verifies integrity of the data segment. More specifically, the consumer may receive a response packet to the requested segment number and validate integrity and originality of the data segment. Hereinafter, step S504 will be described in greater detail.

The response packet may include segment and digest information corresponding to the requested segment number. The digest may include information on a Merkle hash, and the Merkle hash may be expressed as being transmitted in the form of the digest. The producer provides a hint about the Merkle root in the form of the digest. The information on the Merkle hash may be generated according to the policy applied by the producer and provided to the consumer. Using such information, the consumer may verify the received data segment.

In one embodiment, the consumer may generate a Merkle root hash using a result of hashing the data segment and the Merkle hash of the received digest. The consumer may complete verification by comparing a Merkle root hash generated by itself with the Merkle hash included in the manifest. When they match as the result of comparison, integrity of the data segment is regarded as being verified, and the consumer may request a next data segment. When they do not match as the result of comparison, integrity of the data segment is regarded as being violated, and thus the consumer may take necessary actions without requesting a next data segment.

In step S505, the above-described procedure is repeated until the last number of the data segment. In step S506, the consumer may verify all data when verification is completed until the last number of the segment of the manifest.

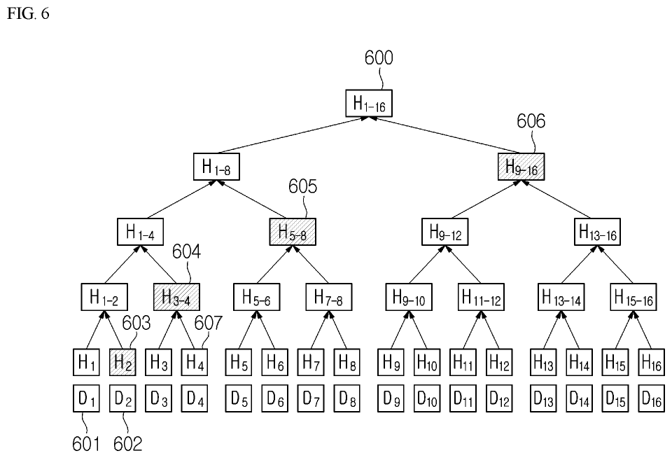

FIG. 6 is a view showing a Merkle tree illustrating single-signature-based data integrity verification applicable to the present invention. Hereinafter, an embodiment according to the single group policy will be described in detail with respect to FIG. 6, as an example of reducing the number of necessary digests using the characteristics of the Merkle tree.

Referring to FIG. 6, the consumer may request data through an interest packet when having the Merkle tree shown in FIG. 6. In one embodiment, the request for the data through the interest packet may have the following format.

/com/ndn/videos/babyshark/avi

The producer which has received the request for the data may transmit Data 0 containing information including the Merkle root in the manifest based on the Merkle tree. In one embodiment, the data containing the information on the Merkle root may have the following form.

/com/ndn/videos/babyshark/avi/#1

. . .

/com/ndn/videos/babyshark/avi/#n

The form of the Merkle root may be expressed as 0x0ab4.

Referring to FIG. 6, the consumer which has received the manifest may request D₁ 601 which is a first data segment according to the manifest. The producer may transmit data D₁ 601 and H₂ 603, H₃₋₄ 604, H₅₋₈ 605 and H₉₋₁₆ 606 which are the digests necessary to compute the Merkle root H₁₋₁₆ 600. The consumer may compute H₁ using the received D₁ 601. In addition, the consumer may compute H₁₋₂ using the received H₂ 603 and H₁ computed by itself. The consumer may compute H₁₋₄ using the recomputed H₁₋₂ and the received H₃₋₄ 604, and compute H₁₋₈ using H₁₋₄ and the received H₅₋₈ 605. The consumer may finally generate the Merkle root using the recomputed H₁₋₈ and the received H₉₋₁₆ 606. The consumer may compare the generated Merkle root with the Merkle root H₁₋₁₆ 600 of the manifest received through the signed packet. When they are the same as a result of comparison, provenance and data integrity are regarded as being validated.

The consumer may request D₂ 602 which is a next segment when the received data has integrity. The producer which has received the request transmits D₂ 602. Unlike D₁ 601, no additional digest transmission is required. The consumer may compute H₂ using D₂ 602 and compare this with the already received H₂ 603. When the Merkle tree has already been verified, further verification is unnecessary. That is, computing of up to the Merkle root H₁₋₁₆ is unnecessary as when the consumer verifies the integrity of D₁. Since the integrity of D₁ has already been verified, the consumer may verify D₂ by comparing H₂ used to compute the Merkle root in the integrity verification process of D₁ with H₂ computed from D₂ by itself.

The consumer may request D₃ which is a next segment. The producer may transmit H₄ 607 which is a digest necessary for verification along with D₃. The consumer may compute H₃ using D₃ and compute H₃₋₄ using the received H₄ 607. The consumer may perform verification by comparing this digest with the already received H₃₋₄ 604. The above procedure may be repeated from D₄ to D₁₆.

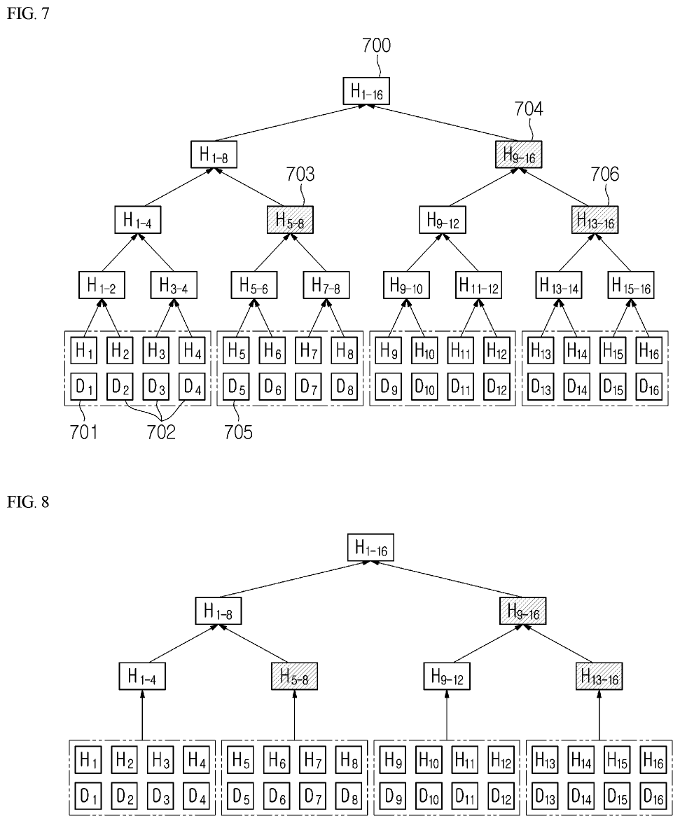

FIG. 7 is a view showing a binary tree illustrating data integrity verification using a segment group applicable to the present invention. An example of reducing verification using a segment group will be described in detail with reference to FIG. 7. In FIG. 7, a segment group size is set to 4.

The consumer may request data through an interest packet. In one embodiment, the request for the data through the interest packet may have the following form.

/com/ndn/videos/real-time/babyshark/avi

The producer which has received the request for the data may transmit Data 0 containing information including the Merkle root in the manifest based on the Merkle tree. In one embodiment, the data containing the information on the Merkle root may have the following form.

/com/ndn/videos/real-time/babyshark/avi/#1

. . .

/com/ndn/videos/real-time/babyshark/avi/#n

The form of the Merkle root may be expressed as 0x0cd2.

The consumer which has received the manifest may request D₁ 701 which is a first data segment according to the manifest. As shown in FIG. 7, the producer may transmit data D₁ 701 and H₅₋₈ 703 and H₉₋₁₆ 704 which are digests necessary to compute the Merkle root H₁₋₈ 700 together. The consumer may request D₂, D₃ and D₄ 702 which are the remaining segments of a first data segment group, without performing verification. Since the size of the data segment group is set to 4, the number of remaining data segments is 3. The producer may transmit the data D₂, D₃ and D₄ 702. The consumer may receive the data segment group having a group size of 4 and compute H₁, H₂, H₃, H₄, H₁₋₂, H₃₋₄ and H₁₋₄ using the received D₁, D₂, D₃ and D₄. The consumer may compute H₁₋₈ using H₅₋₈ 703 received together with H₁₋₄ as a result of computing. In addition, the consumer may finally generate the Merkle root H₁₋₁₆ using the computed H₁₋₈ and the received H₉₋₁₆ 704. The consumer may compare the generated Merkle root with the signed Merkle root H₁₋₁₆ 700. When both Merkle roots are the same through the comparison, provenance and integrity are regarded as being verified.

The consumer may request D₅ 705 which is a next segment when the received data has integrity. The producer may transmit D₅ 705. Unlike D₁ 701, no additional digest is required. The consumer may request D₆, D₇ and D₈ which are the remaining segments of the data segment group without performing segment verification. The producer may transmit the data D₆, D₇ and D₈. The consumer may receive the data segment group and compute H₅, H₆, H₇, H₈, H₅₋₆, H₇ and H₅₋₈ using the received D₅, D₆, D₇ and D₈. The consumer may compare H₅₋₈ which is the result of computing with the received H₅₋₈ 703. When they are the same as the result of comparison, provenance and data integrity are regarded as being verified. That is, computing of up to the Merkle root H₁₋₁₆ is unnecessary as when the consumer verifies the integrity of a previous data segment group. Since the integrity of the previous data segment group has already been verified, the consumer may verify a second data group by comparing H₅₋₈ used to compute the Merkle root in a previous integrity verification process with H₅₋₈ computed by itself.

The consumer may request D₉ which is a next segment when the received data has integrity. The producer may transmit D₉. Unlike the previous data segment group, as an additional digest, only H₁₃₋₁₆ 706 is necessary. The consumer may request D₁₀, D₁₁ and D₁₂ which are the remaining segments of the data segment group, without performing segment verification. The producer may transmit the data D₁₀, D₁₁ and D₁₂. The consumer may receive the data segment group and compute H₉, H₁₀, H₁₁, H₁₂, H₉₋₁₀, H₁₁₋₁₂ and H₉₋₁₂ using the received D₉, D₁₀, D₁₁ and D₁₂. The consumer may generate H₉₋₁₆ using H₉₋₁₂ which is the result of computing and the received H₁₃₋₁₆ 706. The consumer may compare H₉₋₁₆ generated by itself with the already received H₉₋₁₆ 703. When they are the same as the result of comparison, provenance and data integrity are regarded as being validated. The above-described procedure may be repeated from D₁₃ to D₁₆.

Referring to FIG. 7, hash values which need to be transmitted are H₅₋₈ 703, H₁₃₋₁₆ 706 and H₉₋₁₆ 704 and the total number thereof is 3. The number of hashes which need to be transmitted is reduced by 2^{(k-2)} as compared to when the size of the group of verification segments is 1 in a tree having the same size. In addition, it can be seen that the number of hashes which need to be transmitted is reduced by 2^{(k-1)} as compared to when the size of the group is 2. In this way, the number of digests which need to be additionally transmitted may be reduced by log₂n according to the segment group size, and 2ⁿ may also be flexibly applied. The following table shows the number of required hashes according to the tree level.

TABLE 1

| tree level | 0 | 1 | 2 | 3 | 4 | 5 | 6 | 7 |
|---|---|---|---|---|---|---|---|---|
| required hash | 0 | 1 | 3 | 7 | 15 | 31 | 63 | 127 |

Referring to FIG. 7, the total number of required digests (sum of required hashes (SRH)) is expressed by Equation 1 below.

$$SRH = {\sum }_{K = 1}^{n} {2}^{( k - 1 )} \qquad Equation 1$$

In Equation 1, n means

$${log}_{2} ( \frac{segments}{group size} ) .$$

SRH means the total number of required digests (sum of required hashes (SRH)).

When a group size is 1 and a tree level is 3, total data may be composed of eight data segments. In this case, the number of required hashes may be expressed by Equation 2 below.

$$SRH = {\sum }_{k = 1}^{3} {2}^{( k - 1 )} \qquad Equation 2$$

In Equation 2, when a group size is 1 and a tree level is 3, a total of seven hashes is required.

When a group size is 2 and a tree level is 3, the number of required hashes is expressed by Equation 3 below.

$$SRH = {\sum }_{k = 1}^{2} {2}^{( k - 1 )} \qquad Equation 3$$

In Equation 3, when a group size is 2 and a tree level is 3, a total of three hashes is required.

When a group size is 4 and a tree level is 3, the number of required hashes is expressed by Equation 4 below.

$$SRH = {\sum }_{k = 1}^{1} {2}^{( k - 1 )} \qquad Equation 4$$

FIG. 8 is a view showing a k-array tree illustrating data integrity verification using a segment group applicable to the present invention. Referring to FIG. 8, it can be seen that the depth may be reduced as compared to construction of the Merkle tree based on a binary tree. The producer may generate and provide a k-array based on logₖ n when generating a segment group. The description after configuring the Merkle uses the same mechanism as the embodiment of FIG. 7.

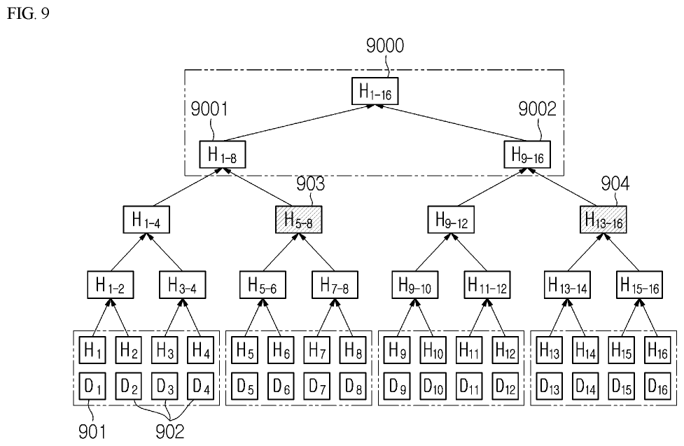

FIG. 9 is a view showing a Merkle tree illustrating data integrity verification using a Merkle hash group applicable to the present invention. A method of setting a verification segment group to 4 and enabling a signature to include not only a Merkle root but also three upper hashes when having the Merkle tree shown in FIG. 9 will be described. A Merkle root including the signature and Merkle hashes including the signature may be expressed as a Merkle hash group. The Merkle hashes of the Merkle hash group may be used interchangeably with a Merkle root. In the present embodiment, three upper Merkle hash nodes are H₁₋₁₆ 9000, H₁₋₈ 9001 and H₉₋₁₆ 9002.

The consumer may request data through an interest packet. In one embodiment, the form of the request for the data through the interest packet may be as follows.

/com/ndn/videos/babyshark/avi

The producer which has received the request for the data may transmit Data 0 containing Merkle root information in a manifest based on the Merkle tree. In one embodiment, the form of transmission of Data 0 containing Merkle root information may be as follows.

/com/ndn/videos/real-time/babyshark/avi/#1

. . .

/com/ndn/videos/real-time/babyshark/avi/#n

The form of the Merkle root is 0x0ab4. The form of H₁₋₈ is 0x0fa2. The form of H₉₋₁₆ is 0x1ab3a.

In this case, whether H₁₋₈ and H₉₋₁₆ match may be verified. The consumer which has received the manifest may request D₁ 901 which is a first segment according to the manifest. The producer may transmit the data D₁ 901 and H₅₋₈ 903 which is a digest necessary to compute the Merkle root H₁ together. Here, H₉₋₁₆ has already received and thus is not required. The consumer may request D₂, D₃ and D₄ 902 which are the remaining segments of the data segment group having a group size of 4, without performing verification. The producer may transmit the data D₂, D₃ and D₄ 902. The consumer may receive the data segment group and may compute H₁₋₈ by adding the received H₅₋₈ 903 together with H₁₋₄ which is the result of computing of H₁, H₂, H₃, H₄, H₁₋₂ and H₃₋₄ using D₁, D₂, D₃ and D₄. When comparison and verification are performed using the computed H₁₋₈ and the already received signed H₁₋₈ 9001, provenance and data integrity are regarded as being validated.

The consumer may request D₅ which is a next segment when the received data has integrity. The producer may transmit D₅. No additional digest is not required. The consumer may request D₆, D₇ and D₈ which are the remaining segments of the data segment group, without performing segment verification. The producer may transmit the data D₆, D₇ and D₈. The consumer may receive the data segment group and compute H₅, H₆, H₇, H₈, H₅₋₆, H₇ and H₅₋₈ using the received D₅, D₆, D₇ and D₈. When comparison is performed using the received H₅₋₈ 903, provenance and data integrity are regarded as being validated. This procedure may be repeated from D₉ to D₁₆. In the present embodiment, by increasing not only the size of the segment verification group but also the number of signed hashes to three upper nodes in addition to the Merkle root, it is possible to reduce the burden of computing of hashes or the number of required hashes.

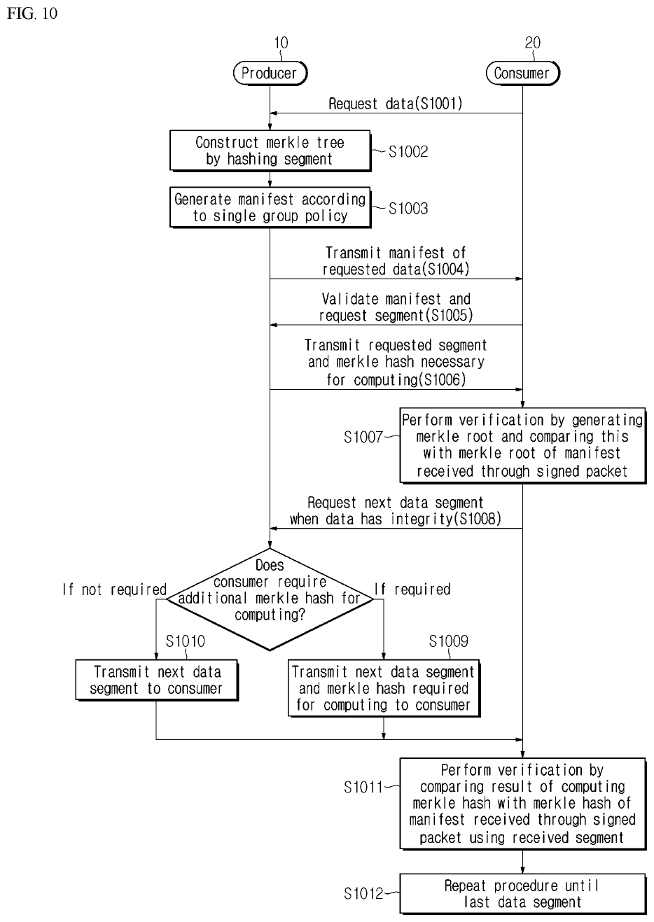

FIG. 10 is a view showing a data integrity verification procedure according to a single group policy applicable to the present invention.

Referring to FIG. 10, in step S1001, the consumer 20 may request data from the producer 10. The consumer 20 may request the data through the name of the data or an interest packet.

In step S1002, the producer 10 may construct a Merkle tree by hashing a data segment. The producer divides the data into segment units. The producer may divide the data into segment units and construct the Merkle tree by hashing the divided data segments. The producer may generate a Merkle root and a Merkle hash by constructing the Merkle tree.

In step S1003, the producer 10 may generate a manifest according to the single group policy. The single group policy is a basic Merkle tree-based verification policy, and the manifest includes a start and end number of a segment and Merkle root hash information.

In step S1004, the producer 10 may transmit the manifest of the data requested by the consumer 20. More specifically, as a first response to the data requested by the consumer, the producer may transmit a manifest file generated by applying the single group policy. This procedure is provided in the form of a signed packet.

In step S1005, the consumer 20 validates the manifest and requests a segment. The received manifest includes number information of the requested segment and Merkle root information. A procedure of receiving the manifest is performed in the form of a signed packet and this procedure completes signature related operation. The consumer may request a data segment based on the validated manifest. The request for the data segment may include a data segment number.

In step S1006, the producer 10 may transmit, to the consumer 20, the requested data segment and a Merkle hash necessary for computing in the form of a digest.

In step S1007, the consumer 20 performs verification by generating a Merkle root and comparing this with the Merkle root of the manifest received through the signed packet. More specifically, the consumer may receive a response packet to the requested segment number and validate integrity and originality of the data segment.

The response packet may include segment and digest information corresponding to the requested segment number. The digest includes information on a Merkle hash. The Merkle hash may be expressed as being transmitted in the form of the digest. The producer provides a hint about the Merkle root in the form of the digest. The information on the Merkle hash may be generated according to the policy applied by the producer, and provided to the consumer. Using such information, the consumer may verify the received data segment.

The consumer may generate a Merkle root hash using a result of hashing the data segment and the Merkle hash of the received digest. The consumer may complete verification by comparing the Merkle root hash generated by itself with the Merkle hash included in the manifest. When they match as the result of comparison, integrity of the data segment is regarded as being verified.

In step S1008, when the data has integrity, the consumer requests a next data segment. When they do not match as the result of comparison, integrity of the data segment is regarded as being violated, and thus the consumer may take necessary actions without requesting a next segment.

When the consumer requires an additional Merkle hash for computing, in step S1009, the producer 10 transmits, to the consumer 20, a next data segment and a Merkle hash necessary for computing. More specifically, the producer may transmit, to the consumer, the next data segment and the Merkle hash necessary for computing in the form of a digest.

When the consumer does not require an additional Merkle hash for computing, in step S1010, the producer transmits the next data segment to the consumer.

In step S1011, the consumer may perform verification by comparing the result of computing Merkle hash with the Merkle hash of the manifest received through the signed packet using received segment. When the Merkle tree has already been verified, the consumer may complete verification by comparison with the Merkle hash used for verification, without generating the Merkle root again.

In step S1012, the above procedure is repeated until a last data segment. When verification of integrity of the data segment is finished by repeating the above procedure until the last data segment, verification of integrity of all data is completed.

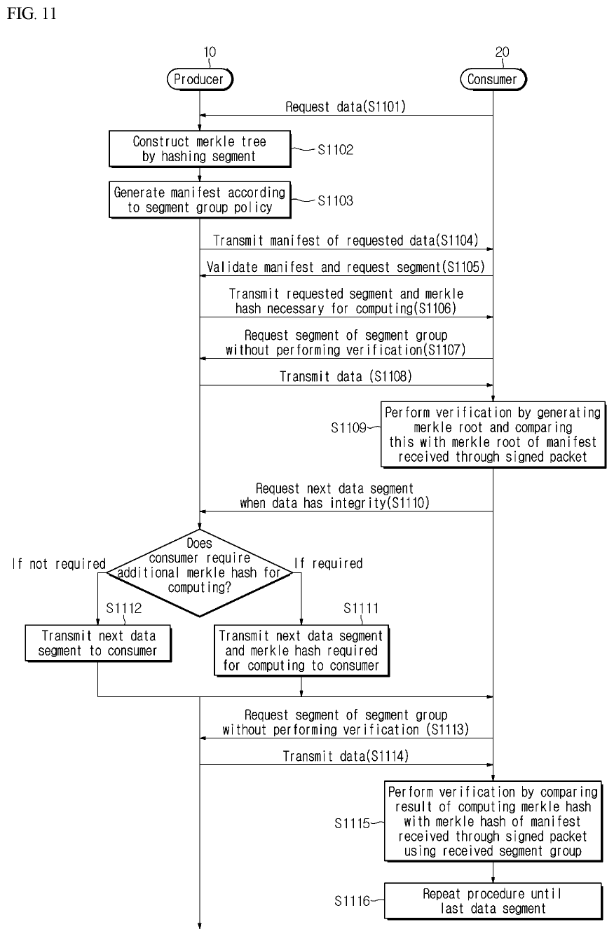

FIG. 11 is a view showing a data integrity verification procedure according to a segment group policy applicable to the present invention.

Referring to FIG. 11, in step S1101, the consumer may request data from the producer. The consumer may request the data through the name of the data or an interest packet.

In step S1102, the producer may construct a Merkle tree by hashing a data segment. The producer may divide the data into segment units and construct the Merkle tree by hashing the divided data segment. The producer may generate a Merkle root and a Merkle hash by constructing the Merkle tree.

In step S1103, the producer may construct a manifest according to the segment group policy. The segment group policy refers to a policy for generating a manifest including Merkle root information and start and end number information of the data segment for each data segment group.

In step S1104, the producer may transmit the manifest of the data requested by the consumer. More specifically, as a first response to the data requested by the consumer, the producer may transmit a manifest file generated by applying the segment group policy. This procedure is provided in the form of a signed packet.

In step S1105, the consumer validates the manifest information and requests a segment. The received manifest includes number information of each data segment of each segment group and Merkle root information. A procedure of receiving the manifest is performed in the form of a signed packet and this procedure completes signature related operation. The consumer may request a data segment based on the validated manifest. The request for the data segment may include a data segment number.

In step S1106, the producer may transmit the requested data segment and a Merkle hash necessary for computing in the form of a digest.

In step S1107, the consumer requests the remaining segments of the data segment group without performing verification. The consumer may reduce the verification step by performing verification in segment group units.

In step S1108, the producer transmits the data segment.

In step S1109, the consumer performs verification by generating a Merkle root and comparing this with the Merkle root of the manifest received through the signed packet. More specifically, the consumer may receive a response packet to the requested segment number and validate integrity and originality of the data segment.

The response packet may include segment and digest information corresponding to the requested segment number. The digest includes information on a Merkle hash. The Merkle hash may be expressed as being transmitted in the form of the digest. The producer provides a hint about the Merkle root in the form of the digest. The information on the Merkle hash may be generated according to the policy applied by the producer, and provided to the consumer. Using such information, the consumer may verify the received data segment.

The consumer may generate a Merkle root hash using a result of hashing the data segment and the Merkle hash of the received digest. The consumer may complete verification by comparing the Merkle root hash generated by itself with the Merkle hash included in the manifest. When they match as the result of comparison, integrity of the data segment is regarded as being verified.

In step S1110, when the data has integrity, the consumer requests a next data segment. When they do not match as the result of comparison, integrity of the data segment is regarded as being violated, and thus the consumer may take necessary actions without requesting a next segment.

When the consumer requires an additional Merkle hash for computing, in step S1111, the producer transmits, to the consumer, a next data segment and a Merkle hash necessary for computing. More specifically, the producer may transmit, to the consumer, the next data segment and the Merkle hash necessary for computing in the form of a digest.

When the consumer does not require an additional Merkle hash for computing, in step S1112, the producer transmits the next data segment to the consumer. In this case, additional digest transmission is not required.

In step S1113, the consumer requests the remaining segments of the data segment group without performing verification. More specifically, the consumer may request the remaining segments of the data segment group in order to perform verification in data segment group units.

In step S1114, the producer transmits the data. More specifically, the producer transmits all the remaining data segments of the data segment group.

In step S1115, the consumer may perform verification by comparing the result of computing Merkle hash with the Merkle hash of the manifest received through the signed packet using received segment group.

In step 1116, the above procedure is repeated until a last data segment. When data integrity verification of all groups is finished by repeating the above procedure until the last data segment group, data integrity verification is completed.

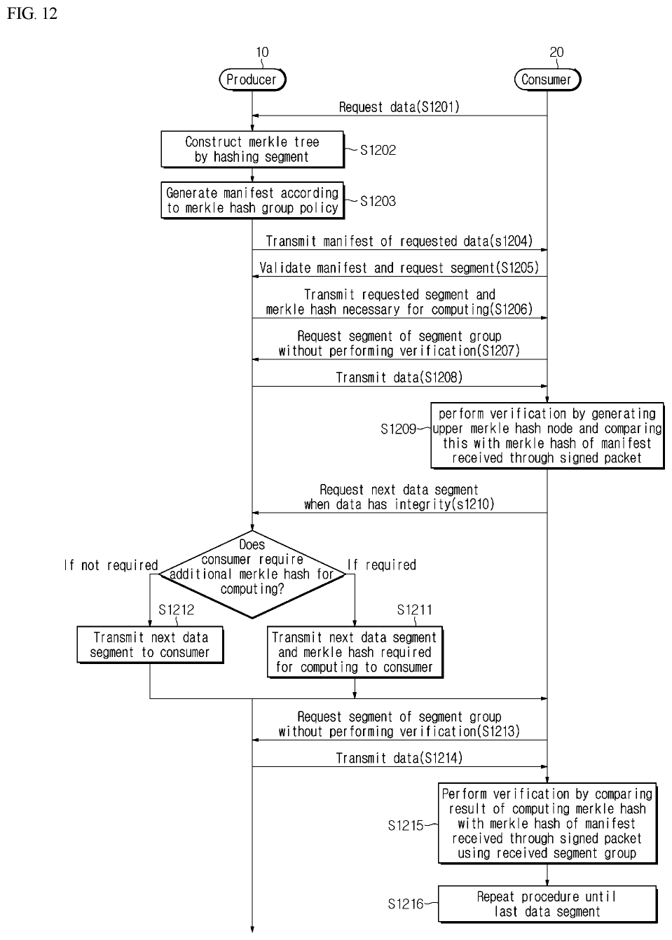

FIG. 12 is a view showing a data integrity verification procedure according to a Merkle hash group policy applicable to the present invention.

Referring to FIG. 12, in step S1201, the consumer may request data from the producer. The consumer may request the data through the name of the data or an interest packet. In step S1202, the producer may construct a Merkle tree by hashing a data segment.

In step S1203, the producer may construct a manifest according to the Merkle hash group policy. The Merkle hash group policy refers to a policy to prepare for the case where the number of segments generated by dividing the data is very large and the number of Merkle hashes to be included in the digest increases to exceed a packet capacity.

In step S1204, the producer may transmit the manifest of the data requested by the consumer. More specifically, as a first response to the data requested by the consumer, the producer may transmit a manifest file generated by applying the Merkle hash group policy. This procedure is provided in the form of a signed packet.

In step S1205, the consumer validates the manifest and requests a first data segment. The received manifest includes number information of each data segment of each segment group and Merkle hash group information. A procedure of receiving the manifest is performed in the form of a signed packet and this procedure completes signature related operation. The consumer may request a data segment based on the validated manifest. The request for the data segment may include a data segment number.

In step S1206, the producer may transmit the requested data segment and a Merkle hash necessary for computing. More specifically, the producer may transmit the requested data segment and a Merkle hash necessary for computing in the form of a digest.

In step S1207, the consumer may request the remaining segments of the data segment group without performing verification. It is possible to reduce the verification step of the consumer by performing verification in segment group units.

In step S1208, the producer transmits the data segment.

In step S1209, the consumer performs verification by generating an upper Merkle hash node and comparing this with the Merkle hash of the manifest received through the signed packet. More specifically, the consumer may receive a response packet to the requested segment number and validate integrity and originality of the data segment.

The response packet may include segment and digest information corresponding to the requested segment number. The digest includes information on a Merkle hash. The Merkle hash may be expressed as being transmitted in the form of the digest. The producer provides a hint about the Merkle root in the form of the digest. The information on the Merkle hash may be generated according to the policy applied by the producer, and provided to the consumer. Using such information, the consumer may verify the received data segment.

The consumer may generate a Merkle root hash using a result of hashing the data segment and the Merkle hash of the received digest. The consumer may complete verification by comparing the Merkle root of the Merkle hash group generated by itself with the Merkle root included in the manifest. When they match as the result of comparison, integrity of the data segment is regarded as being verified.

In step S1210, when the data has integrity, the consumer requests a next data segment. When they do not match as the result of comparison, integrity of the data segment is regarded as being violated, and thus the consumer may take necessary actions without requesting a next segment.

When the consumer requires an additional Merkle hash for computing, in step S1211, the producer transmits, to the consumer, a next data segment and a Merkle hash necessary for computing. More specifically, the producer may transmit, to the consumer, the next data segment and the Merkle hash necessary for computing in the form of a digest.

When the consumer does not require an additional Merkle hash for computing, in step S1212, the producer transmits the next data segment to the consumer. In this case, additional digest transmission is not required.

In step S1213, the consumer requests the data segment of the data segment group without performing verification. More specifically, the consumer may request the remaining segments of the data segment group in order to perform verification in data segment group units.

In step S1214, the producer transmits the data. More specifically, the producer transmits all the remaining data segments of the data segment group.

In step S1215, the consumer may perform verification by comparing the result of computing Merkle hash with the Merkle hash of the manifest received through the signed packet using the received segment group.

In step S1216, the above procedure is repeated until a last data segment. When data integrity verification is finished by repeating the above procedure until the last data segment group, data integrity verification is completed.

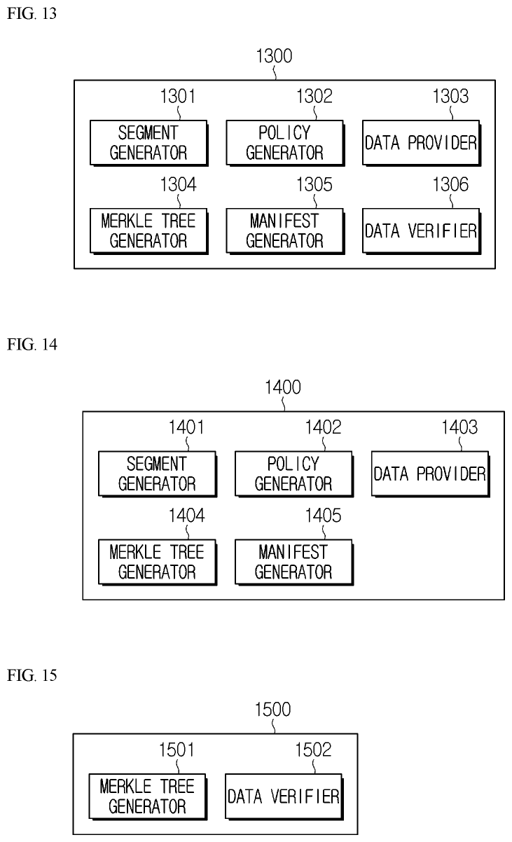

FIG. 13 is a view showing a block structure applicable to the present invention. The components illustrated in FIG. 13 are functional blocks and may be physically implemented by one or more circuits. The blocks of FIG. 13 describe the whole, but may autonomously be constructed as necessary. Each component will now be described.

A segment generator 1301 may divide data into pieces to generate data segments, when the size of the data provided by the producer exceeds a limit. The data divided into the pieces may be referred to as segments. The size of the segment may be determined by the producer. A Merkle tree generator 1304 constructs the Merkle tree by hashing each segment because the producer knows the data segment. The Merkle tree generator may construct a Merkle tree using an encryption hashing scheme. In the case of the consumer, the Merkle tree generator may construct the Merkle tree using the downloaded segment and the Merkle hash information transmitted together. The Merkle hash information is included in the digest. The policy generator 1302 may construct a policy for providing data. Each policy will be described below in detail.

The single group policy provides a Merkle hash for each segment. The consumer requests all segments in order and performs verification every time. The segment group policy bundles segments into appropriate units and provides the appropriate units, because the number of segments increases when a file unit is large. The consumer performs verification after a segment group is downloaded. In the Merkle hash group policy, when the level of the Merkle tree generated by the producer is very deep, the number of digests to be provided to the segments may exceed an allowable range. The producer may provide a bundle of Merkle hash units in preparation for such a case. Accordingly, it is possible to reduce the verification depth of the consumer. The policies may be used independently or together.

A manifest generator 1305 may generate a manifest file including the order of segments and information on the Merkle hash as data to be first provided in response to the request of the consumer. The manifest is generated according to the policy designated by the producer.

The single group policy includes Merkle root information and a segment start and end number. The consumer may send a request including a segment number based on the manifest and perform verification after receiving the segment.

The segment group includes Merkle root information and segment group information. The segment group information includes a start and end number of a segment corresponding to each group. The consumer may transmit a request including a segment number based on the manifest and perform verification after receiving the segment in the designated group units. A binary segment group may not be used. The k-array Merkle tree may be used, and an object of the k-array Merkle tree is to reduce the level of the tree. The number of digests which need to be additionally transmitted may be expressed as logₖ n (k: array, n: the number of segments).

In the case of a Merkle hash, Merkle hash group information includes a Merkle hash number of each level. Segment and segment group information may be used. The consumer may construct an upper part of the Merkle tree using the Merkle hash group included in the received manifest, send a request including the segment number, and perform verification by performing comparison with the constructed Merkle tree when the segment is received.

In a data provider 1303, the producer may provide the data according to the request of the consumer. A first packet provided by the producer provides a manifest file through a signed packet, and Merkle hash information capable of verifying the segment and the segment requested by the consumer are sent together in the form of a digest from a second packet.

In a data verifier 1306, the consumer validates the manifest file received through the signed packet, receives the data in segment units according to the request, computes the Merkle hash through the result of hashing the segment and digest computing using the digest information included for each segment, and compares this result with the Merkle hash result included in the manifest, thereby performing the verification procedure.

FIG. 14 is a view showing an apparatus used by a producer, which is applicable to the present invention. A segment generator 1401 may divide data into pieces to generate data segments, when the size of the data provided by the producer exceeds a limit. The data divided into the pieces may be referred to as segments. The size of the segment may be determined by the producer. A policy generator 1402 may construct a policy for providing the data when segment and the Merkle tree construction is completed. A data provider 1403 may provide the data according to the request of the consumer. A Merkle tree generator 1404 may construct a Merkle tree by hashing each segment, because the data segment is known. In addition, a Merkle tree generator 1404 may construct a Merkle tree using an encryption hashing scheme. A manifest generator 1405 may generate a file including the order of segments and information on the Merkle hash as data to be first provided according to the request of the consumer. The manifest is generated according to the policy designated by the producer.

FIG. 15 is a view showing an apparatus used by a consumer, which is applicable to the present invention. A Merkle tree generator 1501 may construct a Merkle tree using the downloaded segment and the Merkle hash information (included in the digest) transmitted together. In addition, the Merkle tree generator 1501 may construct the Merkle tree using the encryption hashing scheme. A data verifier 1502 verifies a manifest file received through a signed packet and receives data in segment units according to the request. The data verifier 1502 may compute a Merkle hash using digest information included for each segment and compare this result with a Merkle hash result included in the manifest, thereby performing a verification procedure.

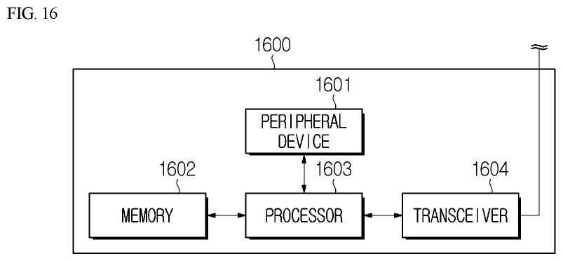

FIG. 16 is a view showing a device applicable to the present invention. Referring to FIG. 16, the device 1600 may include a memory 1602, a processor 1603, a transceiver 1604 and a peripheral device 1601. In addition, for example, the device 1600 may further include other components, without being limited to the above-described embodiments. At this time, for example, the device may operate based on the above-described NDN system. More specifically, the device 1600 of FIG. 16 may be an exemplary hardware/software architecture such as an NDN device, an NDN server or a content router. At this time, for example, the memory 1602 may be a non-movable memory or a movable memory. In addition, for example, the peripheral device 1601 may include a display, a GPS or other peripheral devices, without being limited to the above-described embodiments. In addition, for example, the device 1600 may include a communication circuit such as the transceiver 1604 and perform communication with an external device based on this.

In addition, for example, the processor 1603 may be at least one of a general processor, a digital signal processor (DSP), a DSP core, a controller, a microcontroller, application specific integrated circuits (ASICs), field programmable gate array (FPGA) circuits, any other types of integrated circuits (ICs) and one or more processors related to state machine. That is, the processor may be a hardware/software component for controlling the above-described device 1600. At this time, the processor 1603 may execute computer-executable instructions stored in the memory 1602 in order to perform various essential functions of a node. For example, the processor 1603 may control at least one of signal coding, data processing, power control, input/output processing or communication operation. In addition, the processor 1603 may control physical layers, MAC layers and application layers. In addition, for example, the processor 1603 may perform authentication and security procedures in an access layer and/or an application layer, without being limited thereto.

In addition, for example, the processor 1603 may perform communication with other devices through the transceiver 1604. For example, the processor 1603 may control the node to perform communication with other nodes via a network by executing the computer-executable instructions. That is, communication performed in the present invention may be controlled. For example, the other nodes may include an NDN server, a content router and the other devices. For example, the transceiver 1604 may transmit a radio frequency (RF) signal through the antenna and transmit signals based on various communication networks. In addition, for example, MIMO technology, beamforming, etc. may be applied as antenna technology, without being limited to the above-described embodiments. In addition, the signals transmitted and received through the transceiver 1604 may be modulated and demodulated and controlled by the processor 1603, without being limited to the above-described embodiments.

According to the present invention, generation and validation of a manifest with per-segment provenance and integrity of a file is possible a certain number of times regardless of the size of the file, thereby reducing burden of computing.

According to the present invention, when a data producer provides a file, a consumer can verify integrity and provenance of a data segment through computing of a Merkle root.

According to the present invention, in providing a large file, it is possible to reduce a verification step by utilizing a segment group policy of the present invention.

According to the present invention, in providing real-time streaming, when a Merkle hash group policy of the present invention is utilized, it is possible to reduce a verification step and to consider mobility.

Various embodiments of the present disclosure are not listed in all possible combinations, but are for describing representative aspects of the present disclosure, and matters described in the various embodiments may be applied independently or may be applied as a combination of two or more.

In addition, various embodiments of the present disclosure may be implemented by hardware, firmware, software, or a combination thereof. In the case of implementing the present disclosure by hardware, the present disclosure may be implemented with one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, or the like. For example, the processor may be implemented by software written in a computer-readable programming language, and may take various forms including the general processor. It is apparent that this may be disclosed in hardware composed of one or more combinations.

The scope of the present disclosure includes software or machine-executable instructions (e.g., operating systems, applications, firmware, programs, etc.) that allow operations according to methods of various embodiments to be executed on a device or a computer, and a non-transitory computer-readable medium which stores such software and instructions and is executable on a device or a computer.

Those skilled in the art appreciate that various substitutions, modifications and changes of the present invention described above are possible without departing from the technical spirit of the present invention, and thus the scope of the present invention is not limited to the above-described embodiments and the accompanying drawings.

In addition, both the product invention and the method invention are described in the specification and the description of both inventions may be supplementarily applied as needed.

What is claimed is:

1. A method of validating data integrity in named data networking(NDN) by a producer device, the method comprising:
generating a data segment and constructing a Merkle tree by hashing the data segment;
transmitting a manifest generated based on a policy; and
transmitting a data segment requested by a consumer and a Merkle hash,
wherein the transmitting of the manifest is performed in the form of a signed packet.

2. The method of claim 1, wherein the Merkle tree is a k-array Merkle tree.

3. The method of claim 1, wherein the Merkle tree is a binary Merkle tree.

4. The method of claim 1, wherein the manifest includes Merkle hash information and order information of the data segment.

5. The method of claim 4,
wherein the policy includes a single group policy, and
wherein the single group policy is a policy in which the Merkle hash information includes a Merkle root and the order information of the data segment includes a start and end number of a data segment.

6. The method of claim 4,
wherein the policy includes a segment group policy, and
wherein the segment group policy is a policy in which the Merkle hash information includes a Merkle root and the order information of the data segment includes a start and end number of a data segment for each data segment group.

7. The method of claim 4,
wherein the policy includes a Merkle hash group policy, and
wherein the Merkle hash group policy is a policy in which the Merkle hash information includes a Merkle hash group and the order information of the data segment includes a start and end number of a data segment for each data segment group.

8. A method of validating data integrity in named data networking(NDN) by a consumer device, the method comprising:
requesting data from a producer;
receiving a manifest generated according to a policy;
receiving a data segment based on the manifest; and
comparing a Merkle hash based on the data segment with a Merkle hash based on the manifest,
wherein the receiving of the manifest is performed in the form of a signed packet.

9. The method of claim 8, wherein the manifest includes Merkle hash information and order information of the data segment.

10. The method of claim 8, wherein the Merkle hash based on the manifest is generated based on a Merkle tree.

11. The method of claim 9,
wherein the policy includes a single group policy, and
wherein the single group policy is a policy in which the Merkle hash information includes a Merkle root and the order information of the data segment includes a start and end number of a data segment.

12. The method of claim 9,
wherein the policy includes a segment group policy, and
wherein the segment group policy is a policy in which the Merkle hash information includes a Merkle root and the order information of the data segment includes a start and end number of a data segment for each data segment group.

13. The method of claim 9,
wherein the policy includes a Merkle hash group policy, and
wherein the Merkle hash group policy is a policy in which the Merkle hash information includes a Merkle hash group and the order information of the data segment includes a start and end number of a data segment for each data segment group.

14. An apparatus for validating data integrity in named data networking (NDN), the apparatus comprising:
a segment generator configured to generate a data segment by dividing data;
a Merkle tree generator configured to construct a Merkle tree by hashing the data segment;
a policy generator configured to construct a policy for providing the data segment;
a manifest generator configured to generate a manifest file generated according to the policy; and
a data provider configured to provide a manifest file in which a first packet provided by a producer is a signed packet.

15. The apparatus of claim 14, wherein the manifest includes Merkle hash information and order information of the data segment.

16. The apparatus of claim 15,
wherein the policy includes a single group policy, and
wherein the single group policy is a policy in which the Merkle hash information includes a Merkle root and the order information of the data segment includes a start and end number of a data segment.

17. The apparatus of claim 15,
wherein the policy includes a segment group policy, and
wherein the segment group policy is a policy in which the Merkle hash information includes a Merkle root and the order information of the data segment includes a start and end number of a data segment for each data segment group.

18. The apparatus of claim 15,
wherein the policy includes a Merkle hash group policy, and
wherein the Merkle hash group policy is a policy in which the Merkle hash information includes a Merkle hash group and the order information of the data segment includes a start and end number of a data segment for data segment group.

19. The apparatus of claim 14, wherein the Merkle tree is a binary Merkle tree.

20. The apparatus of claim 14, wherein the Merkle tree is a k-array Merkle tree.
